(19) United States
(12) Patent Application Publication
(10) Pub. No.: US 2006/0170970 A1
(43) Pub. Date: Aug. 3, 2006

(54) Method for defining an imposition plan

(76) Inventors: Chris Tuijn, Lier (BE); Peter De Mangelaere, Deinze (BE); Roger Baeten, Boortmeerbeek (BE)

Correspondence Address: AGFA CORPORATION;LAW & PATENT DEPARTMENT, 200 BALLARDVALE STREET, WILMINGTON, MA, 01887, US

(21) Appl. No.: 11/339,179

(22) Filed: Jan. 25, 2006

Related U.S. Application Data
(60) Provisional application No. 60/648,025, filed on Jan. 28, 2005.

(51) Int. Cl. G06K 15/00

(52) U.S. Cl. 358/1.18

(57) ABSTRACT

A method for defining an imposition plan for producing a first portion of a first printed product and a second portion of a second printed product, the method including (a) defining a first run list of the first portion; (b) defining a second run list of the second portion; (c) including a first page of the first run list and a second page of the second run list in a signature of the imposition plan for producing the first portion of the first printed product and the second portion of the second printed product.

The application claims the benefit of US Provisional Application No. 60/648,025 filed on Jan. 28, 2005.

### FIELD OF THE INVENTION

The present invention relates to printed products and particularly to digital representations of such printed products.

### BACKGROUND OF THE INVENTION

The Graphic Arts Industry

The graphic arts industry deals with products such as magazines, catalogues, packaging, promotional or corporate materials, books, specialty products. Such products are called “printed products”, or simply “Products”, in this document. The printed products are typically produced using offset, flexographic, screen, gravure, digital, sheet- or web-fed printing presses.

Referring to FIG. 1, the production of a printed product in what is called in this document the “Graphic Enterprise” involves an intense professional interaction between at least three parties.

A first party is the print buyer 110, 111. The print buyer is a customer. He may be a publisher (for example of magazines or books) or a corporate organization (as for corporate documents or in the packaging industry) or a pre-press house that acts upon one of the former. In large organizations, the print buyer may also be also be an in-house pre-press department.

A second party is the work center 120. The work center is the entity where the actual transformation from digital input documents to printed product takes place.

A third party is the customer service representative 130. He serves as the middle man between a print buyer and the work center.

Overview Workflow

Referring to FIG. 2, a typical workflow in the Graphic Enterprise could be as follows. After a definition step 200 of a printed product by the print buyer, the customer service representative interprets the needs of the print buyer in technical terms and communicates them to the work center. Based on feedback from the work center, the customer service representative calculates a cost of the print project and quotes a price to the print buyer. If a deal is made, the print buyer submits 210 to the customer service representative the input materials. The work center processes these input materials into a softcopy or hardcopy proof for customer approval. If necessary, the customer gives instructions to correct the proof. This customer approval cycle 220 is managed by the customer service representative and may be repeated a few times until final approval by the customer is obtained. After the customer approval, the manufacturing process 230 of the printed product can be initiated followed by delivery and billing 240.

Manufacturing Process: Production Plan

Based on the availability of presses, paper stock, inks and finishing equipment the production planning department makes a production plan. The same department also defines the physical structure of the product. With physical structure is meant how the publication is divided into sections, what the size of said sections is and how they are bound together to make up the final product.

Having the sections identified, the production planning department can also determine how the sections are to be printed. The topological mapping of the logical page order of a section to page positions and orientations on the printing plate leads to the definition of the signatures and the imposition layout. In fact, printing presses print an entire set of pages on a single large sheet of paper to make the most efficient use of the paper and to shorten the time required for printing a large number of different pages. “Inposition” is the process of arranging the individual pages on the sheet of paper so that after they are printed, folded and trimmed, the resulting pages will back up correctly and be in the proper order. The pages are arranged on a large sheet called a “flat”—which is also called a “printing sheet” is this document.

For more information on terms such as sections, signatures, imposition, run lists, etc. we refer to the “Handbook of Print Media, Technologies and Production Methods”, Kipphan H., Springer-Verlag, 2001, herein incorporated by reference in its entirety for background information only.

Digital Content Management; Software Tools

One of the challenges in the printing industry is to ensure that the right digital content ends up correctly in the final publications. The content assignment can be broken up into two separate steps. In a first step, the customer assigns the digital content to logical pages of the final printed product. In order to check if this first step has been performed correctly, the customer approves the content assignment using a reader's spread view of the product. An example of such a reader's spread is shown in FIG. 3 and visualizes the pages of a small regional newspaper row by row in such a way as if the reader was browsing through the printed product.

A second step is carried out in the prepress department and includes putting the logical pages correctly in run lists for the imposition process.

Different software tools are used within the Graphic Enterprise, such as pre-press workflow systems (such as Apogee Series 3 and Apogee X from Agfa), cost estimation modules, Management Information Systems (MIS), etc. Most of these tools operate on a digital representation of the product that will be printed. Agfa's Delano™ software allows the players in the Graphic Enterprise to interact and to make a digital representation of a printed product.

Patent application no. WO 01/16790, herein incorporated by reference in its entirety for background information only, discloses a software based method for simultaneously associating multiple, ordered collections of pages with multiple impositions. A document's reader order list of pages represented in an imposition description file are decoupled from any single imposition. The decoupling mechanism is a software object called a pageset having positions associated with the pages of the document. A pageset may be associated with more than one imposition plan; more than one pageset may be associated with a single imposition plan; or more than one pageset can be associated with more than one imposition plan.

There is still a need for an improved method for making imposition plans for printed products.

### SUMMARY OF THE INVENTION

The present invention is a method for defining an imposition plan, as claimed in independent claims 1 and 6. Preferred embodiments of the invention are set out in the dependent claims. Preferably, a method in accordance with the invention is implemented in a computer program product as claimed in independent claims 25 and 30. The invention also includes a data processing system as claimed in independent claims 15 and 20.

FIG. 7 illustrates a preferred embodiment of the present invention. In steps 410 and 420 a first and a second run list are defined, and in step 430 a signature of an imposition plan is defined that includes a first page of this first run list and a second page of this second run list.

In one embodiment, the first run list pertains to a first portion of a first printed product and the second run list pertains to a second portion of a second printed product, wherein the first and the second portion are different from each other; the first and second printed products may be different from each other or they may in fact be the same printed product (i.e. the first and the second printed product are two instances of the same printed product). In another embodiment, the second portion equals the first portion and the second printed product equals the first printed product and the second run list is another instance of the first run list.

An advantage of the embodiment wherein the first and second printed products are different from each other is cross product manufacturing: e.g. covers of different printed products, or even pages of different products, may be put on one sheet.

In a particular embodiment, the first portion, the second portion, or both, are so-called Parts: in Delano, a Part is selected from the group including of a cover, content and an insert of a printed product; Part are discussed more in detail further below. An advantage of this embodiment is that pages of different Parts within one Product may be combined on one printing sheet.

Thus, in these embodiments an imposition plan is defined based on two run lists, and the two run lists are combined with each other in such a way that a first page of the first run list and a second page of the second run list are included in a signature of the imposition plan. This is opposed to patent application no. WO 01/16790, discussed above, wherein a choice is made of a single pageset out of a plurality of pagesets, and the imposition plan is defined by means of that single pageset.

The present invention also includes a computer program product for defining an imposition plan for producing a first portion of a first printed product and a second portion of a second printed product, the computer program product including a computer readable medium; first program instructions for defining a first run list of the first portion; second program instructions for defining a second run list of the second portion; third program instructions for including a first page of the first run list and a second page of the second run list in a signature of the imposition plan for producing the first portion of the first printed product and the second portion of the second printed product; wherein the first, second and third program instructions are recorded on the computer readable medium.

In this document, a page, a section and other suchlike terms may denote the physical entity, the digital representation of the physical entity, a depiction thereof on a computer display. What is meant, can be determined from the context.

A computer program denotes, in this document, an aggregate of computer program code means, that may be organized in one entity, or in a plurality of entities that may run independently of each other (e.g. generating a product structure for a printed product, and generating, based on that product structure, an imposition plan for the printed product, may be performed by two different entities: the first entity generates the product structure, and the second entity generates the imposition plan; both entities together are denoted, in this document, as “a computer program”).

### BRIEF DESCRIPTION OF THE DRAWINGS

The invention is described with reference to the following drawings without the intention to limit the invention thereto, and in which:

FIG. 1 shows the interaction between the parties in the “Graphic Enterprise”;

FIG. 2 shows a typical workflow in the Graphic Enterprise;

FIG. 3 shows an example of a readers spread view;

FIG. 4 and FIG. 5 show a section list;

FIG. 6 shows signatures containing different signature portions; and

FIG. 7 shows a flowchart of an embodiment of the invention.

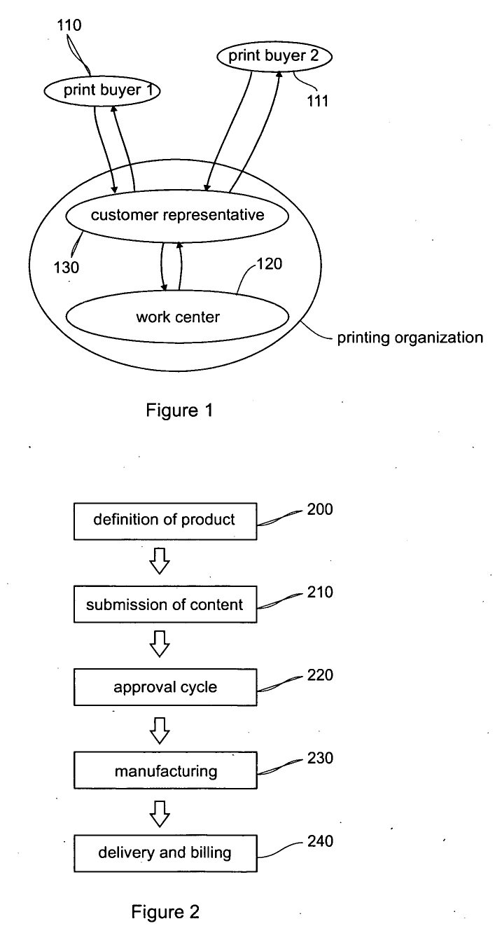

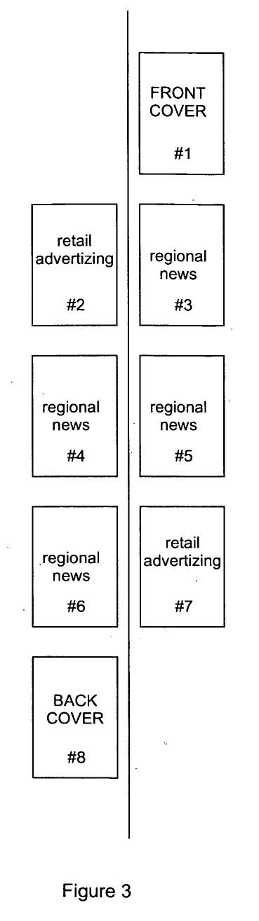

### DETAILED DESCRIPTION OF THE PREFERRED EMBODIMENTS

A specific embodiment of the invention is encompassed in a project management system that organizes and streamlines the work within the Graphic Enterprise.

The invention is further illustrated hereinafter especially by embodiments as implemented in the new version of Agfa's Delano™ software (which was released as version 2.0 around May, 2005), and also by other embodiments, implemented in Delano version 1.1 (which was exhibited at DRUPA in April 2004), without the intention to limit the invention to these disclosed embodiments.

Delano allows the user to make digital representations of printed products, and to perform operations on these digital representations, as will become clear from the following embodiments.

In Delano 1.1, the possibilities to define imposition schemes (also called imposition plans in this document) were extended by introducing the functions to merge and split Production Components and to allow editing of the run list. Then, an imposition layout structure could be created through the automatic selection of signatures out of an imposition template.

Now, in the new version of Delano (i.e. the one released as version 2.0), new, powerful functionality has been provided that allows to manually select signatures out of imposition templates. Full multi section support within signatures (within one Product and across different Products) has been provided as well.

In this document, we first briefly describe how the imposition specification has been implemented in the old versions 1.0 and 1.1 of Delano. Then, we explain what the ideas behind the new Delano imposition functionality are and how they are made available in the GUI.

For more information on the used terminology, we refer to the existing Delano 1.2, and to the corresponding manuals and documentation, which are incorporated herein by reference.

First, some Delano background is discussed.

Products and Parts

In Delano, a Product may include different Parts. A Part may be a cover, content, an insert. An insert is printed material, typically one or more advertisements, that is inserted between the content pages. Usually, inserts do not affect the pagination of the content; if e.g. an insert of four pages is located between page seven and page eight of the content, page eight retains its page number and does not get page number twelve. A cover may or may not be present (a self-cover means that there is no separate cover: the outer pages of the content serve as the cover). A printed product may contain two or more content Parts; an example of a printed product that contains two content Parts is a printed product containing two books, one in French and one in Dutch, so that by turning the printed product so that front and back are switched, one obtains the book in the other language.

With each Part, a list of pages is associated that are visualized in the so-called Page Status View. In addition to the so-called PDF box information (Art/safety, Trim, Bleed and Media Box), all the Pages have a specific position in the Reader's Spread View. The list of pages that is associated with a specific Part is often referred to as the Page List.

Creation Components

For each Part that is created (either during the Product creation or via a manual Part creation), a Creation Component and a Production Component will be made.

With each Component, a Task Chain can be associated that specifies how the related resources will be processed.

In a preferred embodiment, the Creation Component will contain only Tasks that work on Pages; the Creation Component created during the Part creation, will process exactly the Pages that are associated with that Part's Page List.

Production Components

During the creation of a Part, one Production Component will be created as well. By default, all the pages of that Part's Page List will be used as the input run list of that Production Component.

The Production Component's Task Chain will convert the incoming Pages as follows:
Imposition: Page are transformed into structured Signatures (Signature, Sheet, Surface);
Rendering, Trapping, . . . , Plate Making: Signatures in, Signatures out;
Printing: Signatures in, Sheets out;
Folding: Sheets in, Folded Sheets out; etc.

The user can create extra Production Components if he wishes to do so. During the creation of a Production Component, the user indicates which Page List he will use as input for the Production Component.

This functionality allows the user to use the same Page List in different print jobs. This can be useful if specific Products are printed in parallel on different presses or if different types of production have to be prepared.

Imposition and Delano 1.0

In Delano 1.0, there are 2 ways to define an imposition scheme, one based on PJTF files and one based on Preps templates.

In order to manufacture a Product Part, different steps have to be taken, as follows.

First, the Production Component is identified. By default, Delano creates one Production Component per Product Part. Delano associates the entire list of pages in the Part (Page List) with the Production Component.

It is, however, also possible to define new Production Components. During the manual creation of a Production Component, the user specifies the Product Part this Component will manufacture.

A first way to define an imposition scheme, based on Preps imposition templates, is as follows. When editing the Production Component, the user can browse in Delano through a list of Preps files. When a Preps file has been selected (and the Component is saved), Delano will start to calculate an imposition layout scheme by using an automatic selection of signatures out of the template. To this end, Delano uses the Apogee X Imposition service which has very similar behavior as the Preps server.

The result is a list of signatures that each consume a part of the Page List (with consuming we mean that the concerned pages out of the Page List are assigned to these signatures).

As a result, Delano will visualize the list of signatures; the user can also have a graphic view of the signatures.

A second way to define an imposition scheme, using PJTF files, is as follows.

PJTF files are CIP3-based files that contain calculated imposition jobs; as such, they include detailed information that describes the different signatures and how pages are positioned on those signatures.

When selecting a PJTF file and saving the Component, Delano will create the signatures as defined in the PJTF file. The signatures can also be viewed graphically.

Imposition and Delano 1.1

In Delano 1.0, the Production Components only contain pages of one Part (Page List).

Delano 1.1 allows the user to merge different Components. In a preferred embodiment, when merging one Component with another one, the first Component's run list is extended with the pages of the second run list, and then the second Component is removed.

In one embodiment, the user can manually edit the run list, in order to make sure that the pages end up on the correct position on the imposition layout.

Thus, pages that come from different Parts (within one Product or across different Products) can be associated with one Production Component.

A signature of the imposition plan, made by the Production Component's Task Chain, may thus include a first page of a first run list of a first Part, and a second page of a second run list of a second Part, which is one embodiment of the present invention.

An advantage is that pages of different Parts within one Product may be combined on one printing sheet. Another advantage is the cross product manufacturing of Parts (such as, e.g., covers) of different Products on one sheet; even pages of different Products may be put on one sheet.

Imposition in the New Version of Delano

From Delano 1.1 on, it is possible to define (multi section) cross-product Components that combine the manufacturing of different Product Parts in one Component. As described before, it sometimes is necessary to manually edit the run list to make sure that the pages end up correctly on the imposition layout; until version 1.2, Delano did not represent the sections in the templates and therefore the run list was defined manually by the user.

In the new version of Delano, the sections (and the signatures they belong to) are represented. Different cases of signature/section combinations will now be discussed.

Single Part Components and Single Section Signature

Let us first consider the simple case in which an ordinary Production Component (which relates to one Part only) needs to be defined. (These single-Part Production Components are the Components that are created by default during the Product Creation. If necessary, it always is possible to create new Production Components that have a Part's run list.)

Before the Production Component can be started, the user specifies how the specific Part should be produced. This basically is equivalent with specifying what sections have to be produced and how they will be combined together. This can be done in Delano by creating a number of signatures each containing one or more sections.

When adding a signature in Delano, the user will have the following possibilities:
to select a template and consume the entire run list using the Auto-Select functionality (see also the discussion above of using Preps imposition templates);
to select a PJTF file and import the signatures that have been defined in this PJTF file (see also the discussion above of using PJTF files);
or create signatures one by one through selection out of a list of available imposition templates.

We will now discuss this last case in detail.

When a user hits the ‘Add signature’ button on the screen, a popup will appear in which the user first indicates which of the three possibilities he prefers. If he chooses for the manual selection of signatures, the system will display a list of available templates per binding style.

First, the binding style is selected. Supported binding styles are: Flat Work; Perfect Bound; Saddle Stitched; Come and Go; Cut and Stack.

Then, the user can select a template out of the list of available templates. After the selection, all the signatures that are defined in this template will be shown on the screen. The user then selects a specific signature out of the template and enters further details.

By clicking on the ‘Set to maximum’ button on the screen, the system will calculate how many signatures of the selected type can still be used for the remaining pages. In a preferred embodiment, the system also displays how many pages are still remaining. By clicking on the OK button, the system will now create the specified number of signatures and will consume a number of remaining pages in this process.

Then, a screen is displayed that shows two tables or lists:
a signature list: this is the list of created signatures;
a sections list: this is the list of sections in these signatures.

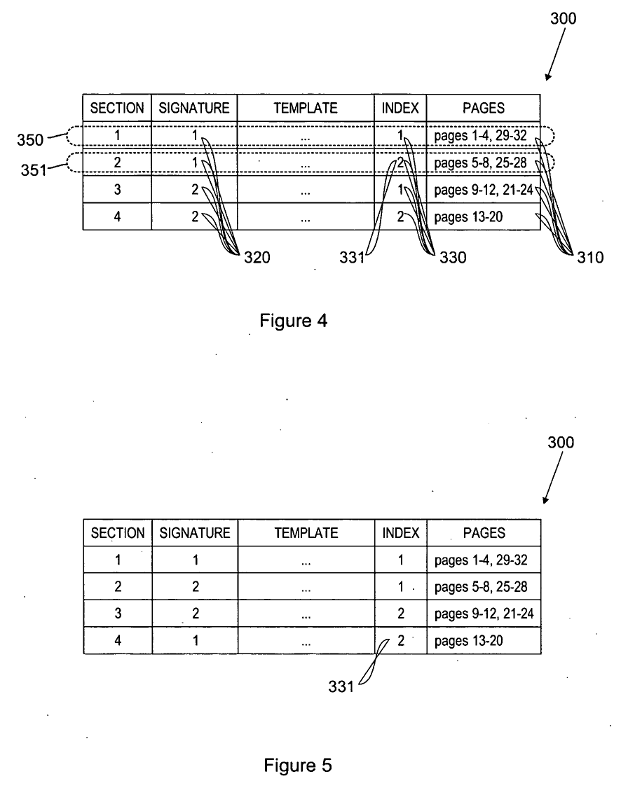

An embodiment of a sections list is shown in FIG. 4 and is discussed further below.

Single Part Components and Multiple Section Signatures

Sometimes, it can be useful to use multiple section signatures when manufacturing a single Product Part. A typical example would be a publication in which a number of sections are in black/white and two non-consecutive sections are in process color.

For cost optimization, it may be advisory to print the two color sections together on one sheet (if possible). If the sections are not next to each other, however, a multiple section signature would be needed.

A typical example is a 32 page saddle stitched brochure including 4 sections wherein the most outer and the most inner section are in color, the other ones in black-and-white.

To illustrate this four-section structure, the following notation is used:
CONTENT(8)*<CONTENT(8)<CONTENT(8)<CONTENT(8) *
i.e. each of the four sections contains eight pages, printed recto-verso; the color pages are marked with an asterisk (*). Remark: in this notation, the horizontal axis models insertion, and the vertical axis models stacking; thus, a perfect bound book, having a cover of 4 pages and containing two sections of 96 pages and one section of 64 pages, is represented as follows:

COVER(4)<CONTENT(96)
<CONTENT(96)
<CONTENT(64)

The 32 page saddle stitched brochure of the example could be realized in Delano by selecting the appropriate saddle stitched template and selecting a 2-section signature of 8+8 pages (i.e. 8 pages recto and 8 pages verso).

In one embodiment, this results in the following signature/section layout. The signature list, i.e. the list of created signatures, is:

Signature
1
2

The sections list, with the sections in these signatures, is shown in FIG. 4. Table 300 contains for each section a list of items 350, 351 (forming a row of the table in FIG. 4). This list of items includes: in the column headed “Section”, a numbering field for the section; in column “Signature”, a signature identifier 320 representing the signature to which the section is assigned; in column “Index”, a signature portion index 330 (discussed immediately below); and in column “Pages”, a field identifying the section—i.e. a section identifier 310—which includes in the shown embodiment the pages of the concerned section.

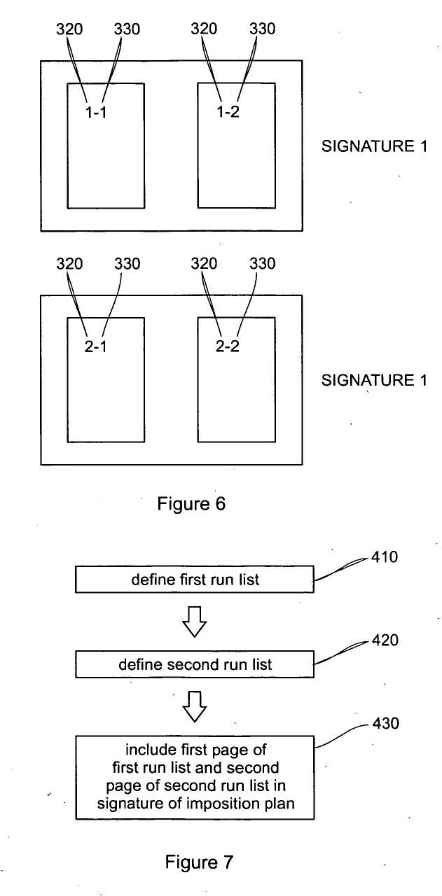

FIG. 6 shows what is meant by a signature portion index 330: signature 1 contains two different signature portions, labeled “1-1” respectively “1-2”, wherein the first number is the signature identifier 320 and the second number is the signature portion index 330. Analogously, signature 2 also contains two signature portions, labeled “2-1” and “2-2”. The case shown in FIG. 4 corresponds to the signature layout of FIG. 6 wherein four pages recto and four pages verso are allocated to a signature portion. Thus, each signature is for 8+8 pages, and together the two signatures suffice for the 32 page saddle stitched brochure.

Returning now to FIG. 4, note that for the saddle stitched brochure the system tries to fill the first signature (with signature identifier 320 equal to “1”) with pages 1-4 and 29-32, and with pages 5-8 and 25-28. In our example, however, we want to print Section 1 (pages 1-4 and 29-32) and Section 4 (pages 13-20) together in one signature (because this is a color signature).

This can easily be realized by moving down the second signature portion of Signature 1 (that is Signature 1, Index 2), corresponding to signature portion index 331 in FIG. 4 (remark: this can be done in the Delano GUI by selecting the concerned section, in this case section 351, and clicking on the blue down arrow on the screen). The result is, as shown in FIG. 5, that this signature portion 331 (now at position 4, but still labeled Signature 1, Index 2) will contain the inner pages 13-20 of the magazine; consequently, these pages (that is, the inner pages) will be printed in color.

Multiple Part Components with Single Signature

Sometimes, it is required to manufacture different Parts together in one Production Component. A typical example of this practice is the printing of covers of different products on one sheet; we will designate the products as product A, product B, product C and product D.

In one embodiment, this is realized as follows.

First, one creates a multi Part Production Component. This can be realized quickly by merging one or more single Part Production Components together.

The result is a Production Component which has different ‘Source Parts’ assigned to it. When adding signatures, the user assigns each section in the signature to a specific Source Part.

In the same notation as used in FIG. 4 (omitting the Template column), the section list for this case is as shown in Table 1:

| Section | Signature | Index | Pages |
|---|---|---|---|
| 1 | 1 | 1 | Cover, 1-4, Part A |
| 2 | 1 | 2 | Cover, 1-4, Part B |
| 3 | 1 | 3 | Cover, 1-4, Part C |
| 4 | 1 | 4 | Cover, 1-4, Part D |

Multiple Part Components with Multiple Signatures

A first example is printing 4 different books together wherein each signature includes a section of each of the 4 books; the books are called B1, B2, B3 and B4 and the section list is shown in Table 2:

TABLE 2

| Section | Signature | Template | Index | Pages |
|---|---|---|---|---|
| 1 | 1 | 4 × 8up | 1 | Content, 1-8 |
| | | | | Content, 25-32, Part B4 |
| 2 | 1 | 4 × 8up | 2 | Content, 1-8 |
| | | | | Content, 25-32, Part B3 |
| 3 | 1 | 4 × 8up | 3 | Content, 1-8 |
| | | | | Content, 25-32, Part B2 |
| 4 | 1 | 4 × 8up | 4 | Content, 1-8 |
| | | | | Content, 25-32, Part B1 |
| 5 | 2 | 4 × 8up | 1 | Content, 9-24, Part B4 |
| 6 | 2 | 4 × 8up | 2 | Content, 9-24, Part B3 |
| 7 | 2 | 4 × 8up | 3 | Content, 9-24, Part B2 |
| 8 | 2 | 4 × 8up | 4 | Content, 9-24, Part B1 |

Variation: as a variation on this theme, one might consider, for instance, a French and an English publication, where the required quantity of the English publications is three times the quantity of the French publications. One might consider printing the publication if possible) on a 4-section signature wherein the three first signature portions are taken by a section of the English publication while the fourth signature portion is taken by the associated section of the French publication.

In order to realize this, we first create a component to which three instances of the English Part and one instance of the French Part are assigned. This can be realized by merging the English Part Production Component once with itself and merging it then again with a newly created English Part Production Component. Then, this component will contain three instances of the English Part run list and therefore it still has to be merged with the French Part component.

Examle: In this example, 75000 copies of an English publication 24 pages content) and 25000 copies of a French publication (24 pages) are generated by repeating the English publication three times on each flat and taking the French publication only once.

The 24 pages are realized with 3 signatures: one 4×8 up signature and twice a 4×2 up signature. The sections are combined using saddle stitching.

The corresponding section list is shown in Table 3:

TABLE 3

| Section | Signature | Template | Index | Pages |
|---|---|---|---|---|
| 1 | 1 | 4 × 8up | 1 | Content, 1-8 |
| | | | | Content, 17-24 |
| 2 | 1 | 4 × 8up | 2 | Content #2, 1-8 |
| | | | | Content #2, 17-24 |
| 3 | 1 | 4 × 8up | 3 | Content #3, 1-8 |
| | | | | Content #3, 17-24 |
| 4 | 1 | 4 × 8up | 4 | Content French, 1-8 |
| | | | | Content French, 17-24 |
| 5 | 2 | 4 × 2up | 1 | Content, 9-10 |
| | | | | Content, 15-16 |
| 6 | 2 | 4 × 2up | 2 | Content #2, 9-10 |
| | | | | Content #2, 15-16 |
| 7 | 2 | 4 × 2up | 3 | Content #3, 9-10 |
| | | | | Content #3, 15-16 |
| 8 | 2 | 4 × 2up | 4 | Content French, 9-10 |
| | | | | Content French, 15-16 |
| 9 | 3 | 4 × 2up | 1 | Content, 11-14 |
| 10 | 3 | 4 × 2up | 2 | Content #2, 11-14 |
| 11 | 3 | 4 × 2up | 3 | Content #3, 11-14 |
| 12 | 3 | 4 × 2up | 4 | Content French, 11-14 |

Thus, in this example, a signature of the imposition plan may include a first page of a first run list of a first Part, i.e. the English Part, and a second page of a second run list of a second Part, i.e. the French Part, which is a particular embodiment of the present invention.

In another example, one might consider printing only English publications using the same signatures as in the example discussed above, i.e. a component would be created to which four instances of the English Part are assigned. In this case, which is another embodiment of the present invention, the imposition plan includes a first page of a first run list of a first Part and a second page of a second run list of a second Part, wherein the first run list is another instance of the second run list.

Of course a run list need not be made for a complete Part; it may also be made for a smaller portion of a printed product, so that one Part has several run lists.

General Behavior

The default Delano behavior will create one Production Component per Part. The Production Planner software module decides which Production Components will be manufactured together. If two or more Production Components have to be realized by one job, they are merged.

The result of this merger is a Production Component that has several Part run lists attached to it. It is also possible to have multiple instances of the same Part associated with a specific Production Component.

In a next phase, the user defines the signatures and sections. This can be done in 2 ways:
1) By selecting one template and using the Auto Select mechanism to define the signatures. In this case, the run list as defined during the merger process will be fed to the Preps server to calculate where which page will go (this is the Delano 1.1 behavior). In this case, the user has to have an in-depth knowledge of the automatic signature selection (and binding style) to make sure that the pages end up at the right positions.
2) By manually selecting the signatures/sections, as illustrated by some examples above.

Assume we have created a Production Component that exists of n Parts; each Part (Pₙ) has a number of pages (run lists) assigned to it (1 . . . pᵢ).

The user now has to consume each of these run lists; with consuming we mean that all the pages of these run lists are assigned to sections in the manually selected signatures.

If a signature has been selected, the user indicates for each section which Part's run list (“Source Part”) will be used. Based on the binding style, the system will then calculate for each section in the signature the pages that will be taken. If the binding style is saddle stitched, half of the pages in the beginning and half of the last remaining pages will be taken, otherwise the pages are taken from the beginning.

This process is repeated until all pages of all Source Parts have been consumed exactly. At that point, the server will start calculating the exact imposition layout. As a consequence, the flat preview will become available in Delano.

In the GUI, two tables are displayed: the table of signatures, and the list of sections in these signatures.

The order in which the sections appear in the GUI corresponds to how they consume the run list within their Source Part.

The user can move these sections up and down; the result is that the pages will end up on other signatures (flats). This can be useful to group all pages that require a specific processing (black/white, process color, HIFI, gloss, special paper etc.).

Example 1: two 16-page brochures to be printed together, using perfect bound signatures with two sections, each containing 8 pages.

Assuming the Parts associated with the two products are called Part1 and Part2, this gives the following sections:

| | | | |
|---|---|---|---|
| Section 1 | Signature 1 | Index 1 | Part1 (1-8) |
| Section 2 | Signature 1 | Index 2 | Part2 (1-8) |
| Section 3 | Signature 2 | Index 1 | Part1 (9-16) |
| Section 4 | Signature 2 | Index 2 | Part2 (9-16) |

Example 2: two 16-page brochures to be printed together, using a saddle-stitch signature with two sections, each containing eight pages.

Assuming the Parts associated with the two products are called Part1 and Part2, this gives the following sections:

| | | | |
|---|---|---|---|
| Section 1 | Signature 1 | Index 1 | Part1 (1-4, 13-16) |
| Section 2 | Signature 1 | Index 2 | Part2 (1-4, 13-16) |
| Section 3 | Signature 2 | Index 1 | Part1 (5-12) |
| Section 4 | Signature 2 | Index 2 | Part2 (5-12) |

Those skilled in the art will appreciate that numerous modifications and variations may be made to the embodiments disclosed above without departing from the scope of the present invention.

What is claimed is :

1. A method for defining an imposition plan for producing a first portion of a first printed product and a second portion of a second printed product, the method comprising:
defining a first run list of said first portion;
defining a second run list of said second portion; and
including a first page of said first run list and a second page of said second run list in a signature of said imposition plan for producing said first portion of said first printed product and said second portion of said second printed product.

2. The method according to claim 1 wherein said second portion equals said first portion and said second printed product equals said first printed product and wherein said second run list is another instance of said first run list.

3. The method according to claim 1 wherein said second portion is different from said first portion.

4. The method according to claim 3 wherein said first printed product equals said second printed product.

5. The method according to claim 3 wherein said first printed product is different from said second printed product.

6. A method for defining an imposition plan for producing a first Part of a first printed product and a second Part of a second printed product, wherein said first Part is selected from the group consisting of a cover, a content and an insert of said first printed product and wherein said second Part is selected from the group consisting of a cover, a content and an insert of said second printed product, the method comprising:
defining a first run list of said first Part;
defining a second run list of said second Part; and
including a first page of said first run list and a second page of said second run list in a signature of said imposition plan for producing said first Part of said first printed product and said second Part of said second printed product.

7. The method according to claim 6 wherein said second Part equals said first Part and said second printed product equals said first printed product and wherein said second run list is another instance of said first run list.

8. The method according to claim 6 wherein said second Part is different from said first Part.

9. The method according to claim 8 wherein said first printed product equals said second printed product.

10. The method according to claim 8 wherein said first printed product is different from said second printed product.

11. The method according to claim 6 further comprising:
identifying a first section of said first Part;
identifying a second section of said second Part;
assigning first pages of said first run list to said first section in said signature, using a first binding style of said first printed product; and
assigning second pages of said second run list to said second section in said signature, using a second binding style of said second printed product.

12. The method according to claim 7 further comprising:
identifying a first section of said first Part;
identifying a second section of said second Part;
assigning first pages of said first run list to said first section in said signature, using a first binding style of said first printed product; and
assigning second pages of said second run list to said second section in said signature, using a second binding style of said second printed product.

13. The method according to claim 9 further comprising:
identifying a first section of said first Part;
identifying a second section of said second Part;
assigning first pages of said first run list to said first section in said signature, using a first binding style of said first printed product; and
assigning second pages of said second run list to said second section in said signature, using a second binding style of said second printed product.

14. The method according to claim 10 further comprising:
identifying a first section of said first Part;
identifying a second section of said second Part;
assigning first pages of said first run list to said first section in said signature, using a first binding style of said first printed product; and
assigning second pages of said second run list to said second section in said signature, using a second binding style of said second printed product.

15. A data processing system for defining an imposition plan for producing a first portion of a first printed product and a second portion of a second printed product, wherein said imposition plan includes a signature, the system comprising:
means for obtaining a first run list of said first portion, wherein said first run list includes a first page of said first portion;
means for obtaining a second run list of said second portion, wherein said second run list includes a second page of said second portion; and
means for including said first page and said second page in said signature.

16. The system according to claim 15 wherein said second portion equals said first portion and said second printed product equals said first printed product and wherein said second run list is another instance of said first run list.

17. The system according to claim 15 wherein said second portion is different from said first portion.

18. The system according to claim 17 wherein said first printed product equals said second printed product.

19. The system according to claim 17 wherein said first printed product is different from said second printed product.

20. A data processing system for defining an imposition plan for producing a first Part of a first printed product and a second Part of a second printed product, wherein said imposition plan includes a signature, wherein said first Part is selected from the group consisting of a cover, a content and an insert of said first printed product, and wherein said second Part is selected from the group consisting of a cover, a content and an insert of said second printed product, the system comprising:
means for obtaining a first run list of said first Part, wherein said first run list includes a first page of said first Part;
means for obtaining a second run list of said second Part, wherein said second run list includes a second page of said second Part; and
means for including said first page and said second page in said signature.

21. The system according to claim 20 wherein said second Part equals said first Part and said second printed product equals said first printed product and wherein said second run list is another instance of said first run list.

22. The system according to claim 20 wherein said second Part is different from said first Part.

23. The system according to claim 22 wherein said first printed product equals said second printed product.

24. The system according to claim 22 wherein said first printed product is different from said second printed product.

25. A computer program product for defining an imposition plan for producing a first portion of a first printed product and a second portion of a second printed product, the computer program product comprising:
a computer readable medium;
first program instructions for defining a first run list of said first portion;
second program instructions for defining a second run list of said second portion; and
third program instructions for including a first page of said first run list and a second page of said second run list in a signature of said imposition plan for producing said first portion of said first printed product and said second portion of said second printed product;
wherein said first, second and third program instructions are recorded on said computer readable medium.

26. The computer program product according to claim 25 wherein said second portion equals said first portion and said second printed product equals said first printed product and wherein said second run list is another instance of said first run list.

27. The computer program product according to claim 25 wherein said second portion is different from said first portion.

28. The computer program product according to claim 27 wherein said first printed product equals said second printed product.

29. The computer program product according to claim 27 wherein said first printed product is different from said second printed product.

30. A computer program product for defining an imposition plan for producing a first Part of a first printed product and a second Part of a second printed product, wherein said first Part is selected from the group consisting of a cover, a content and an insert of said first printed product and wherein said second Part is selected from the group consisting of a cover, a content and an insert of said second printed product, the computer program product comprising:
a computer readable medium;
first program instructions for defining a first run list of said first Part;
second program instructions for defining a second run list of said second Part; and
third program instructions for including a first page of said first run list and a second page of said second run list in a signature of said imposition plan for producing said first Part of said first printed product and said second Part of said second printed product;
wherein said first, second and third program instructions are recorded on said computer readable medium.

31. The computer program product according to claim 30 wherein said second portion equals said first portion and said second printed product equals said first printed product and wherein said second run list is another instance of said first run list.

32. The computer program product according to claim 30 wherein said second portion is different from said first portion.

33. The computer program product according to claim 32 wherein said first printed product equals said second printed product.

34. The computer program product according to claim 32 wherein said first printed product is different from said second printed product.

35. The computer program product according to claim 30 further comprising:
fourth program instructions for identifying a first section of said first Part;
fifth program instructions for identifying a second section of said second Part;
sixth program instructions for assigning first pages of said first run list to said first section in said signature, using a first binding style of said first printed product; and
seventh program instructions for assigning second pages of said second run list to said second section in said signature, using a second binding style of said second printed product;
wherein said fourth, fifth, sixth and seventh program instructions are recorded on said computer readable medium.

36. The computer program product according to claim 31 further comprising:
fourth program instructions for identifying a first section of said first Part;
fifth program instructions for identifying a second section of said second Part;
sixth program instructions for assigning first pages of said first run list to said first section in said signature, using a first binding style of said first printed product; and seventh program instructions for assigning second pages of said second run list to said second section in said signature, using a second binding style of said second printed product;
wherein said fourth, fifth, sixth and seventh program instructions are recorded on said computer readable medium.

37. The computer program product according to claim 33 further comprising:
fourth program instructions for identifying a first section of said first Part;
fifth program instructions for identifying a second section of said second Part;
sixth program instructions for assigning first pages of said first run list to said first section in said signature, using a first binding style of said first printed product; and
seventh program instructions for assigning second pages of said second run list to said second section in said signature, using a second binding style of said second printed product;
wherein said fourth, fifth, sixth and seventh program instructions are recorded on said computer readable medium.

38. The computer program product according to claim 34 further comprising:
fourth program instructions for identifying a first section of said first Part;
fifth program instructions for identifying a second section of said second Part;
sixth program instructions for assigning first pages of said first run list to said first section in said signature, using a first binding style of said first printed product; and
seventh program instructions for assigning second pages of said second run list to said second section in said signature, using a second binding style of said second printed product;
wherein said fourth, fifth, sixth and seventh program instructions are recorded on said computer readable medium.
